(19) United States
(12) Patent Application Publication
(10) Pub. No.: US 2021/0223132 A1
(43) Pub. Date: Jul. 22, 2021

(54) SYSTEMS AND METHODS FOR DETECTING MOISTURE LEAKS OR MOISTURE INGRESS

(71) Applicant: Breen Energy Solutions, Bridgeville, PA (US)

(72) Inventors: Daniel T. Menniti, Houston, TX (US); Prince A. Philip, Canonsburg, PA (US); Robert L. Branning, Atlantic Beach, FL (US); Nicholas S. Saxman, Pittsburgh, PA (US)

(21) Appl. No.: 17/154,784

(22) Filed: Jan. 21, 2021

Related U.S. Application Data
(60) Provisional application No. 62/963,953, filed on Jan. 21, 2020.

(51) Int. Cl. G01M 3/00; B01J 19/00; G01M 3/18

(52) U.S. Cl. CPC G01M 3/002; B01J 2219/00256; G01M 3/18; B01J 19/002

(57) ABSTRACT

A system and method for detecting moisture leaks or moisture ingress into industrial processes by using a probe to determine the presence of condensing process gasses, the probe being configured to improve the probe's ability to reduce the leakage of the gas stream being probed.

### CROSS REFERENCE TO RELATED APPLICATION(S)

This Application claims the benefit of U.S. Provisional Patent Application Ser. No. 62/963,953, filed Jan. 21, 2020. The entire disclosure of the above document is herein incorporated by reference.

### BACKGROUND OF THE INVENTION

### 1. Field of the Invention

The invention relates generally to detecting moisture leaks or moisture ingress into industrial processes. More particularly, this invention relates to systems and methods for detecting moisture leaks or moisture ingress in industrial manufacturing of sulfur trioxide and/or sulfuric acid.

### 2. Description of the Related Art

Sulfur trioxide (SO₃) is an important industrial chemical. The chemical's primary industrial use is as a precursor to the creation of sulfuric acid (H₂SO₄). Sulfur trioxide is also an essential reagent in sulfonation reactions.

Sulfuric acid may be manufactured by oxidizing sulfur dioxide (SO₂) gas to sulfur trioxide in a converter through a catalytic oxidation process. The most common methods for producing the feedstock, sulfur dioxide, include: (a) burning elemental sulfur; (b) collecting and filtering byproducts from a primary process, such as copper smelting; and (3) decomposing sulfoxylic acid (H₂SO₂) (also known as hyposulfurous acid or sulfur dihydroxide) in a spent acid regeneration process. The sulfur dioxide produced from these processes may then be passed over a catalyst, such as vanadium pentoxide (V₂O₅), in the presence of oxygen (O₂) to oxidize it into sulfur trioxide. The sulfur trioxide may be subsequently absorbed into highly concentrated sulfuric acid to form oleum (H₂S₂O₇), also known as fuming sulfuric acid. The oleum may then be diluted with water to form concentrated sulfuric acid.

As sulfur trioxide is produced prior to forming oleum in the process described above, a gas stream laden with the sulfur trioxide within the manufacturing system is typically used to transfer the sulfur trioxide gas from storage to a reaction/production area. The gas stream itself is typically segregated from the remainder of the manufacturing system using, for example, ductwork. This gas stream needs to be kept at least substantially moisture-free because the presence of any moisture in a sulfur trioxide gas stream will likely form a highly concentrated sulfuric acid condensate prior to the oleum formation. If this highly concentrated sulfuric acid condensate forms on any surface in the manufacturing system, such as the sulfuric acid production equipment or ductwork, damage may occur at least due to the extremely corrosive nature of concentrated sulfuric acid.

Unfortunately, moisture may unintentionally enter into sulfur trioxide gas streams in a variety of ways, including without limitation drying tower malfunctions, moisture being introduced at a feed source, leaks in boiler tubing, leaks in economizer tubing, cleaning system malfunctions, and other ways known to persons of ordinary skill in the art. FIG. 9 depicts a block diagram of a system for producing sulfuric acid and related areas for potential moisture leaks within the system for producing sulfuric acid. In addition to the production of unwanted acidic condensates, introducing moisture into a sulfur trioxide stream may result in the unintended production of hydrogen gas (H₂), which gas may pose an explosion or fire hazard in the presence of oxygen and an ignition source. Sulfuric acid producers, therefore, typically need to regularly or continuously monitor the moisture content within sulfur trioxide gas streams. Such processes do not directly monitor the sulfuric acid properties of the gas stream, however.

On the other hand, industries having flue gas have had a need to monitor flue gas streams containing sulfur trioxide. In some cases, sensing equipment installed in the ducting of the gas stream may be used to monitor the characteristics of that gas stream. In other cases, industrial probes may be inserted into the ducting to perform this monitoring.

Prior industrial probes related to sulfur trioxide do not measure moisture but are designed for measuring the content of sulfur dioxide or sulfur trioxide gas in flue gas streams, which streams may be the waste gas from a variety of industrial processes and where sulfur trioxide is desired to be removed prior to the flue gas being exhausted to the environment to avoid it forming into acid rain. One such prior industrial probe is described in U.S. Pat. No. 8,256,267, the entire disclosure of which is hereby incorporated by reference. FIG. 1 depicts an embodiment of such a prior probe (40) that may be used for measuring the content of sulfur trioxide in flue gas streams. Overall, the probe (40) has a body (42) that serves as a structural base. Further, the probe (40) has an end cap or tip (44) having an outer surface (49) that is fitted with: (a) a temperature sensor and (b) two exposed electrical contacts spaced apart on a nonconductive portion of the outer surface (49). Further, the probe (40) has a cooling tube (46) and a heating coil (45) that may provide to the outer surface (49) a stream of cooling air or a stream of heating air, respectively. Cool air from the cooling tube (46) may be ejected around the outer surface (49), and hot air from the heating coil (45) may be ejected around the outer surface (49) at an open end (47) of the heating coil (45).

The outer surface (49) is typically nonconductive, and, accordingly, current is typically unable to flow between the electrical contacts across the outer surface (49). However, current may flow in the presence of a conductive condensate formed on the outer surface (49) continuously between the electrical contacts. As a result, the electrical contacts on the outer surface (49) may be used to determine the presence of a conductive material (such as, without limitation, sulfuric acid) condensing on the outer surface (49) by monitoring a current flow (or lack thereof) from one contact to the other. As used herein, the term “nonconductive” means any conductivity less than or equal to the conductivity of deionized water at room temperature.

To evaluate the composition of the flue gas, the outer surface (49) will be heated and cooled to cyclically condense and evaporate components of the flue gas stream onto the outer surface (49). By determining the temperatures at which these gas stream components condense and evaporate, the components of the gas in the flue gas stream may, at least in part, be determined. The probe (40) is designed to be inserted directly into the ductwork for a flue gas stream to be monitored, wherein the probe (40) will be mounted onto an entrance point and attached to the ductwork and entrance point via a mounting flange (41). When mounted, the entirety of the probe (40) from the mounting flange (41) to the end of the heating coil (45) near the outer surface (49) will be positioned within the ductwork.

The above-described probe and process for measuring the content of sulfur trioxide in flue gas streams are unsuitable for measuring or detecting the presence of water in sulfur trioxide gas streams even though the above-described probes, by detecting the presence of sulfuric acid, detect the presence of sulfur trioxide and moisture in the flue gas. Regarding the above probe process, it may be unsuitable for use in a sulfur trioxide gas stream due, in part, to the increased amount of sulfur trioxide in a sulfur trioxide gas stream when compared to a flue gas stream. This increased amount of sulfur trioxide may cause additional wear on the probe due to the increased quantity and concentration of the sulfur trioxide and/or sulfuric acid that may condense on the probe in a sulfur trioxide gas stream. Although the probe may be able to withstand some corrosive acid exposure, the use of a prior probe process in a sulfur trioxide gas stream will result in the formation of significantly more corrosive materials. Further, the increased amount of quantity and concentration of the sulfur trioxide and/or sulfuric acid that may condense on the probe may affect the sensitivity of the probe itself, as relatively more condensate may appear during a condensation event. This larger loading of the sensors may require more expensive sensors having a greater dynamic range. In some cases, the increased quantities of condensate may reduce the overall sensitivity of the probe, and, in severe cases, all but eliminate the probe's ability to make determinations beyond a binary present or not present determination.

Regarding the flue gas probe itself, such a probe may be susceptible to leaking process gasses, which is unacceptable for a sulfur trioxide gas stream. This is generally due to the fact that sulfur trioxide will typically produce sulfuric acid in the presence of moisture, as discussed above, and that moisture is ever-present in ambient air. Thus, any leaks to the ambient air from a duct holding a sulfur trioxide gas stream will likely produce sulfuric acid, which may be hazardous to personnel and objects/machinery surrounding the ductwork for the sulfur trioxide gas stream if a leak is created. Such leaks may also cause other environmental concerns because the emissions of sulfur containing products are typically regulated by environmental agencies, regulations, or laws. Moreover, these concerns may be magnified relative to those related to a flue gas stream at least because of the increased sulfur trioxide concentration within a sulfur trioxide gas stream. Thus, there may be a particular need to prevent any gas or other leaks from a sulfur trioxide gas stream.

Further, the above-described probe, and similar probes, may leak when, and if, they fail or break. For example, flue gas streams are typically maintained at relatively low pressures, which pressures are often at or near atmospheric pressure, when compared to the pressures maintained for typical sulfur trioxide streams. As a result, probes made for flue gas streams are not designed to handle significant pressures, and may fail at higher pressures due to the forces from the pressure exerted in and on the probe. Further, in part because such prior probes are not designed to operate in higher-pressure and/or highly-caustic environments, the prior probes do not include sufficient failsafe features to protect against possible probe failures. Thus, the above-described flue gas probe may be unsuitable for higher-pressure and/or highly-caustic applications.

Moreover, typical prior flue gas probes only require sealing after installation. On the other hand, a probe for use in a sulfur trioxide stream must remain hermetically sealed even during insertion of the probe into any ducting. Thus, at least for the above reasons, there is a need for a probe to detect moisture ingress into an sulfur trioxide gas stream thorough condensation of sulfur trioxide and/or sulfuric acid due to the reaction of sulfur trioxide gas with moisture in the gas stream that is designed to operate in the hostile environment of a sulfur trioxide gas stream and that will better guard against any leakage of sulfur trioxide even upon failure.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are systems and methods for detecting moisture leaks or moisture ingress in an industrial process. Such industrial processes include, without limitation, the industrial manufacturing of sulfur trioxide and/or sulfuric acid.

Because of these and other problems in the art, there is described herein, among other things, is an industrial probe comprising: a frame portion having an elongated shape; a first sensor having an outer nonconductive surface supporting a plurality of electrical contacts; a cooling portion having at least one conduit configured to cool the first sensor to a cooling temperature; a heating portion having at least one conduit configured to heat the first sensor to a heating temperature; wherein the first sensor is located proximate to a first terminal end of the frame portion; wherein the heating temperature is greater than the cooling temperature; and wherein the first sensor is repeatedly cycled between the cooling temperature and the heating temperature.

In an embodiment of the industrial probe, the heating temperature is approximately 350 degrees Fahrenheit or higher and the cooling temperature is within a range between approximately 250 degrees Fahrenheit and approximately 285 degrees Fahrenheit.

In another embodiment of the industrial probe, the first sensor is configured to be cooled to a test temperature, the test temperature being approximately 240 degrees Fahrenheit.

In another embodiment of the industrial probe, the cooling portion further comprises an inlet and an outlet, each being located proximate to a second terminal end of the frame portion and each having a ball valve configured to be normally closed.

In another embodiment of the industrial probe, the industrial probe further comprises a source of cooling air and a source of heating air, wherein the source of cooling air and the source of heating air are each located remotely from the frame portion.

In another embodiment of the industrial probe, the industrial probe further comprises a mechanical deflector that is configured to protect the first sensor from impacts.

In another embodiment of the industrial probe, the mechanical deflector includes a plurality of open sections that are each configured to allow the first sensor to come into contact with a gas in an environment proximate to the first sensor.

In another embodiment of the industrial probe, the industrial probe further comprises a second sensor, the second sensor being located downstream of the outlet and being capable of detecting the presence of sulfur trioxide within the cooling air.

In another embodiment of the industrial probe, the frame portion is substantially cylindrical in form.

In another embodiment of the industrial probe, the frame portion is generally smooth on its exterior.

In another embodiment of the industrial probe, the industrial probe further comprises wiring connected to each electrical contact of the plurality of electrical contacts, and wherein the wiring is positioned to extend through a gland that is located proximate to the second terminal end of the frame portion.

In another embodiment of the industrial probe, the industrial probe is configured to prevent the transmission of an unwanted gas through the industrial probe in the event that the unwanted gas enters the industrial probe at the first terminal end of the frame portion.

In another embodiment of the industrial probe, the heating temperature is below a process temperature of a sulfur trioxide stream monitored by the probe and the cooling temperature is above the dew point of the sulfur trioxide in the sulfur trioxide stream.

In another embodiment of the industrial probe, the first sensor is configured to be cooled to a test temperature, the test temperature being cooler than the dew point of the sulfur trioxide in the sulfur trioxide stream.

In another embodiment of the industrial probe, the first sensor is configured to be cooled to a test temperature, the test temperature being cooler than the cooling temperature.

In another embodiment of the industrial probe, the heating portion is a sulfur trioxide stream monitored by said probe.

Further, described herein, among other things, is a method for detecting moisture ingress into a sulfur trioxide stream, the method comprising: providing an industrial probe, the industrial probe comprising: a first sensor having an outer nonconductive surface supporting a plurality of electrical contacts; a cooling portion having at least one conduit configured to cool the first sensor to a cooling temperature; and a heating portion having at least one conduit configured to heat the first sensor to a heating temperature; cooling the first sensor to a cooling temperature; heating the first sensor to a heating temperature, the heating temperature being greater than the cooling temperature; monitoring a current flow between the plurality of electrical contacts; and indicating moisture ingress if the current is greater at the cooling temperature than at the heating temperature.

In an embodiment of the method, the heating temperature is below a process temperature of the sulfur trioxide stream and the cooling temperature is above the dew point of the sulfur trioxide in the sulfur trioxide stream.

In another embodiment of the method, the method further comprises a step of cooling the first sensor to the test temperature, the test temperature being cooler than the dew point of the sulfur trioxide in the sulfur trioxide stream.

In another embodiment of the method, the heating temperature is approximately 350 degrees Fahrenheit or higher and the cooling temperature is within a range between approximately 250 degrees Fahrenheit and approximately 285 degrees Fahrenheit.

In another embodiment of the method, the method further comprises a step of cooling the first sensor to the test temperature, the test temperature being approximately 240 degrees Fahrenheit.

### BRIEF DESCRIPTION OF THE DRAWINGS

FIG. 1 depicts such a prior probe used for measuring the content of sulfur trioxide in flue gas streams.

FIG. 2 depicts an exploded view of an embodiment of a probe in accordance with this application.

FIG. 3 depicts a perspective view of an assembled embodiment of the probe depicted in FIG. 2.

FIG. 4 depicts another perspective view of the assembled embodiment of the probe depicted in FIG. 2.

FIG. 5 depicts a top view of the assembled embodiment of the probe depicted in FIG. 2.

FIG. 6 depicts a side view of the assembled embodiment of the probe depicted in FIG. 2.

FIG. 7 depicts a detailed view of an embodiment of a glass sensor for use in a probe in accordance with this application.

FIG. 8 depicts probe temperatures and probe currents from a probe being operated using an embodiment of an above the dew point process in accordance with this application.

FIG. 9 depicts a block diagram of a system for producing sulfuric acid and related areas for potential moisture leaks within the system for producing sulfuric acid.

FIG. 10 depicts a block diagram of a method of using a probe in accordance with this application.

FIG. 11 depicts a block diagram of a method of operating a probe in accordance with this application.

### DETAILED DESCRIPTION OF THE PREFERRED EMBODIMENT(S)

The following detailed description illustrates the invention by way of example and not by way of limitation. This description clearly enables one skilled in the art to make and use the invention, and describes several embodiments, adaptations, variations, alternatives, and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. In addition, it will be understood that the phraseology and terminology used herein is for the purpose of description and should not be regarded as limiting.

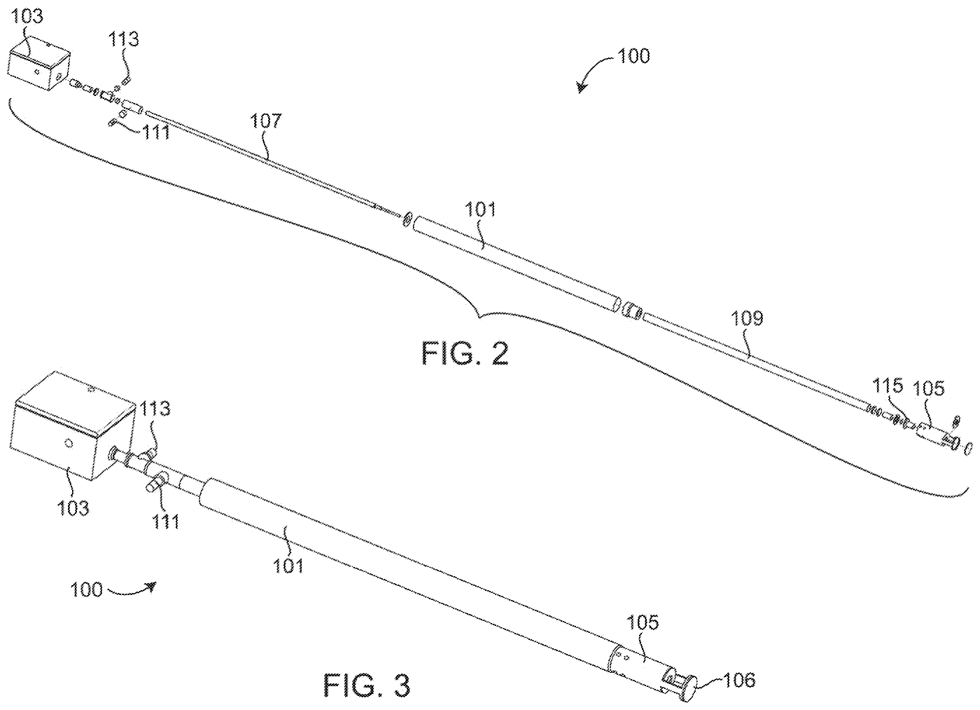

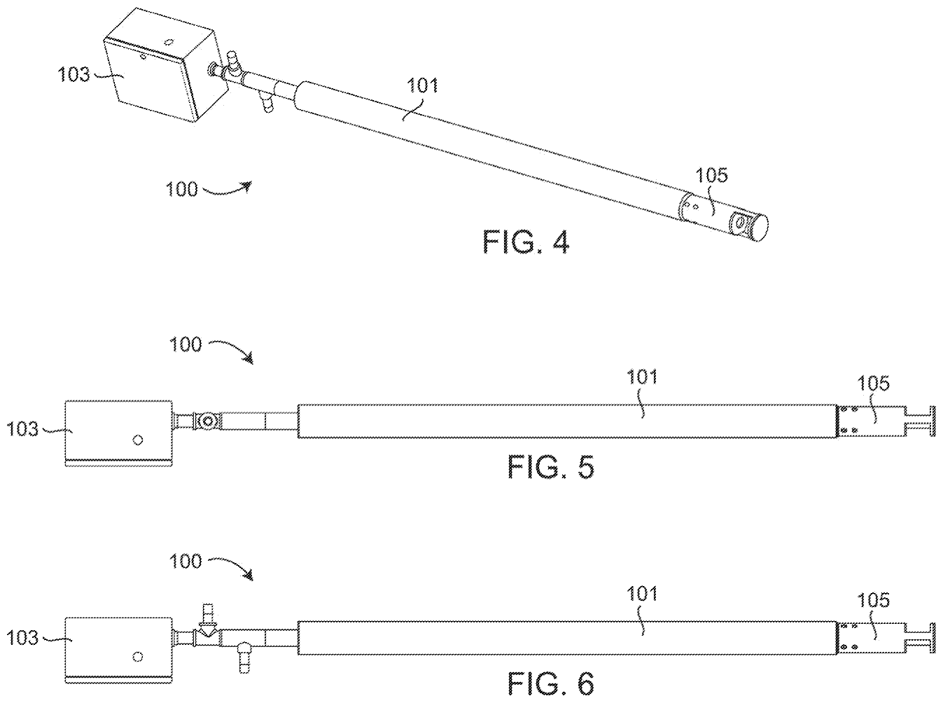

Referring to the drawings, and particularly referring to FIGS. 2, 3, 4, 5, and 6, a probe (100) comprises a body portion (101), an enclosure portion (103), and a tip portion (105). FIG. 2 depicts an exploded view of the probe (100). As can be seen in FIG. 2, the probe (100) also includes a cooling air inlet (111), a cooling air outlet (113), and a glass sensor (115). The glass sensor (115) may be positioned within the tip portion (105) when the probe (100) is in an assembled state. Such an assembled state is depicted in FIGS. 3 through 6. FIG. 3 depicts a perspective view of an assembled embodiment of the probe (100). FIG. 4 depicts a perspective view of the probe (100) at an angle that differs from the view provided in FIG. 3. FIG. 5 depicts a top view of the probe (100), while FIG. 6 depicts a side view of the probe (100) wherein the probe (100) has been rotated 90° along its major axis.

The body portion (101) will typically be formed as a long tube, which may serve as a structural component that connects and supports the enclosure portion (103) and the tip portion (105). Further, this connection may allow the body portion (101) to function as a conduit for materials and signals to pass from one end of the probe (100) to the other. The body portion (101) will typically be the longest section of the probe (100). The body portion (101) of the probe (100) may be made of any material capable of withstanding the stresses of being used as a probe and further capable of withstanding the corrosive environment to which the probe (100) may be subjected. Such materials include, without limitation, various metals, such as titanium or stainless steel. In an embodiment, the body portion (101) may be made from 316 stainless steel.

Further, in the depicted embodiment, the body portion (101) may have a generally cylindrical cross-sectional shape. This generally cylindrical cross-sectional shape may be preferred because it may facilitate the feeding of the probe (100) into mounting flanges provided in ductwork that contains a sulfur trioxide gas stream. In other embodiments, the body portion (101) may have any other cross-sectional shape. Further, the body portion (101) will typically be generally smooth on its exterior. This smoothness may facilitate insertion of the probe (100) into ductwork for a sulfur trioxide gas stream.

The probe (100) may include a cooling tube (107) and an inner tube (109) within its inner volume, typically within the body portion (101). The cooling tube (107) may be used to connect the cooling air inlet (111) to the cooling air outlet (113), and further to allow cooling air to reach the glass sensor (115) during use. The inner tube (109) may carry both the cooling tube (107) and wiring (120) used to couple the glass sensor (115) to electronics stored with the enclosure portion (103). The inner tube (109) may also carry anything else required by the probe (100). In the depicted embodiment, the cooling air inlet (111) and the cooling air outlet (113) extend orthogonality from the probe (100) in opposite directions. However, other orientations of the cooling air inlet (111) and cooling air outlet (113) may be used, as long as the cooling air inlet (111) and cooling air outlet (113) are sufficiently accessible. In other embodiments, the cooling air inlet (111) and the cooling air outlet (113) may be associated with another portion of the probe (100), such as the enclosure portion (103) or the tip portion (105).

Typically, the cooling tube (107) will be configured to convey cooling air to a position proximate to the glass sensor (115), so that the cooling air may cool the glass sensor (115) during use. In other embodiments, the cooling tube (117) itself may have any construction and configuration that facilitates such conveyance. The cooling air inlet (111) and the cooling air outlet (113) may each have any type of closure mechanism known to persons of ordinary skill in the art, which closure mechanism may be used to control the passage of cooling air through the probe (100). In some embodiments, valves may be used. In some of those embodiments, valves that are normally closed, or default to a closed state, may be used. For example, such valves may be fitted with control and power systems capable of closing the valves if the valves are open during an event, such as a power outage or a failure of the probe (100). The valves themselves may be ball valves in some embodiments.

The tip portion (105) will typically be formed as a generally cylindrical cap located on one end of the body portion (101). This location and construction allows the tip portion (105) to serve as an end cap for the body portion (101) and as a protecting shroud for the glass sensor (115). Similar to the body portion (101), the tip portion (105) may also be made from any material that is capable of withstanding stresses of being used as a probe and further capable of withstanding the corrosive environment to which the probe (100) may be subjected. Such materials include, without limitation, various metals, such as titanium or stainless steel. In an embodiment, the tip portion (105) may be made from 316 stainless steel. Although the tip portion (105) is depicted as having a generally circular cross-sectional shape, any cross-sectional shape may be used. Further, although the tip portion (105) is shown as being separate from the body portion (101), any construction may be used. Such constructions may include ones wherein any two or more parts discussed herein are formed integrally, or separately. In some embodiments, the tip portion (105) may be omitted. In the embodiment depicted in FIG. 3, the tip portion (105) includes one or more open sections that are each configured to allow the glass sensor (115) to come into contact with the gas in the surrounding environment.

The tip portion (105) may further include a mechanical deflector (106) at the distal end of the tip portion (105). The mechanical deflector (106) of the tip portion (105) may provide the benefit of protecting the glass sensor (115) from impacts as the probe (100) is inserted into ductwork for a given sulfur trioxide gas stream. For example, the probe (100) may be inserted into a ball valve or other opening within the ductwork for a sulfur trioxide gas stream. While the probe (100) is being inserted into a ball valve or other opening, the tip portion (105) may impact a portion of the ductwork, valve, other opening, or other obstruction. The mechanical deflector (106) may provide sufficient protection to the glass sensor (115) such that the relatively frail glass sensor (115) may be shielded from damage by avoiding mechanical impacts.

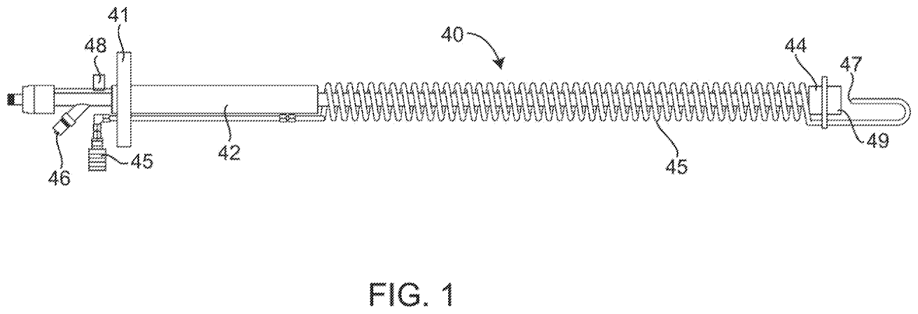

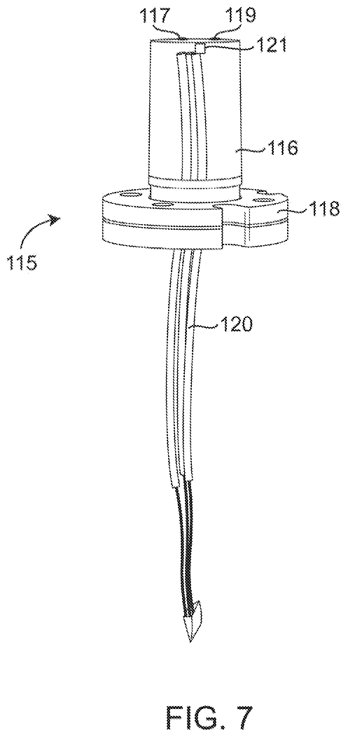

FIG. 7 depicts a detailed view of an embodiment of a glass sensor (115). The glass sensor (115) may comprise a flange portion (118), a first electrical contact (117), a second electrical contact (119), a glass housing (116), a thermal sensor (121), and a plurality of connecting wires (120). The outer surface of the glass sensor (115) may resemble the outer surface (49) depicted in FIG. 1. For example, the outer surface of the glass sensor (115) may include the first electrical contact (117) and the second electrical contact (119), which contacts may be connected to electronics within the enclosure portion (103) via at least one of the plurality of wires (120). In other embodiments, more of less electrical contacts may be used. Further, the thermal sensor (121) may also be connected to electronics within the enclosure portion (103) via at least one of the plurality of wires (120). In other embodiments, some or all of the electronics may be located elsewhere, even remote from the probe (100). The glass sensor (115) may be positioned within the tip portion (105) via the flange portion (118) of the glass sensor (115). In other embodiments, the glass sensor (115) may be positioned elsewhere so long as the glass sensor (115) has sufficient access to the gas stream to be probed. The glass housing (116) may provide a generally sealed connection between the interior of the probe (100) and the environment being tested by the probe (100). The glass sensor (115) may be formed of any mixture of any type of glass. In some embodiments, the glass sensor (115) may be any material(s) capable of fulfilling the functions of the glass sensor (115). For example, without limitation, the glass sensor (115) will typically be made from a material that is nonconductive. If the material is conductive, the outer surface will typically be made nonconductive by any means known to persons of ordinary skill in the art.

The enclosure portion (103) will typically be formed having a shape that provides some volume, allowing it to serve as a protective housing for electrical and other components of the probe (101). The enclosure portion (103) of the probe (100) may be made of any material capable of withstanding the stresses of being used as a probe and further capable of withstanding the corrosive environment in which the probe (100) may be subjected. Such materials include, without limitation, various metals, such as titanium or stainless steel. In an embodiment, the enclosure portion (103) may be made from 316 stainless steel. In the depicted embodiment, the enclosure portion (103) may be shaped like a generally rectangular prism. However, the enclosure portion (103) may have any general shape as long as the shape may accommodate any internal electronics or other material to be housed within the enclosure portion (103). In other embodiments, the enclosure portion (103) may be remote from the probe (100).

As discussed above, the enclosure portion (103) may contain various electronics required to monitor the temperature sensor (121) and the current flowing between the first electrical contact (117) and the second electrical contact (119). Such electronics may take any form known to persons of ordinary skill in the art. Further, the plurality of wires (120) from the glass sensor (115) may enter into the enclosure portion (103) through a gland. The use of such a gland may seal the enclosure portion (103) from the ambient environment around the probe (100) that is outside of the ductwork containing the sulfur trioxide gas stream to be monitored. Accordingly, if the glass sensor (115) fails or is otherwise compromised, which may allow sulfur trioxide gas to enter into the probe (100), the sulfur trioxide gas will remain sequestered within the probe (100). As a result of this sequestering and containment, the probe (100) may protect against unintentional leakage of sulfur trioxide gas to the ambient environment around the probe (100) and external to the ductwork carrying the sulfur trioxide gas stream. In some embodiments, wireless communications may be used for part or all of any communications required for the operation of the probe (100).

In some embodiments, any of the various parts of the probe (100), including without limitation the enclosure portion (103), the body portion (101), and the tip portion (105), may be permanently or semi-permanently affixed to each other. For example, in some embodiments, the enclosure portion (103), the body portion (101), and the tip portion (105) may be welded (or otherwise bonded) together. In other embodiments, the components of the probe (100) may be more or less permanently held together by any means know to those of ordinary skill in the art. In some embodiments, the various components of the probe (100) may be configured to be remote from any other portion. In yet other embodiments, the various components of the probe (100) may be repeatedly removable without damage from each other.

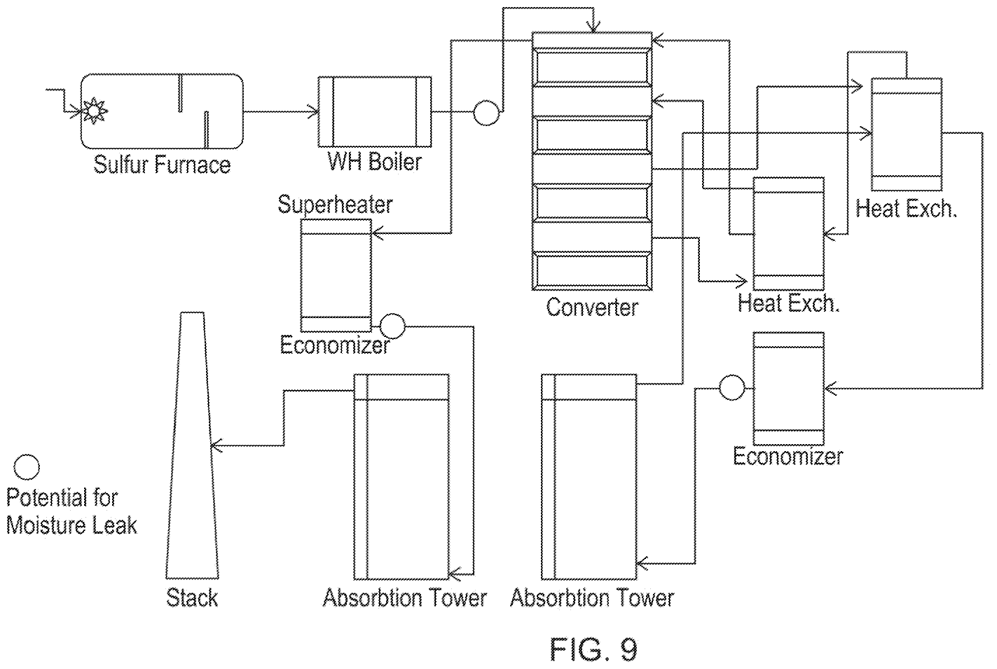

When the probe (100) is inserted into a mounting flange within ductwork carrying a sulfur trioxide gas stream, the probe (100) may be secured using any means known to persons of ordinary skill in the art. For example, the probe (100) may be secured using a stainless steel nut (not shown) and a nylon ferrule (not shown) by securing a mounting flange (not depicted) on the probe (100) to a mounting flange on a ball valve or other opening in the ductwork. Such a securing system may completely seal the probe (100) to the ductwork carrying the sulfur trioxide gas stream. In some embodiments, the stainless steel used may be 316 stainless steel. In other embodiments, the nut may be made from any other material suitable for forming such a nut. Further, the ferrule may be made of any other material known to persons of ordinary skill in the art. The probe (100) may be placed at or downstream of any of the possible locations for a potential moisture leak indicated in FIG. 9.

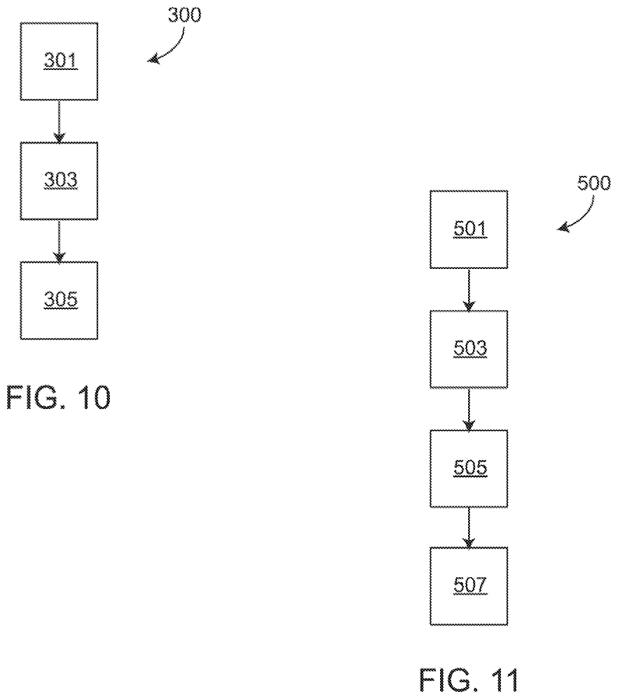

A method (300) of using the probe (100) is depicted in FIG. 10 and will now be described. In particular, a probe may first be acquired and brought to a gas stream to be monitored (301). Next, the probe (100) may be inserted into ductwork containing a sulfur trioxide gas stream (303). The probe (100) may then be operated using an above the dew point cycle (305). Such an above the dew point cycle may allow the probe (100) to operate in the ductwork at a temperature higher than the dew point of the relevant sulfur trioxide gas but low enough to detect an increase or step change in the dew point of the material within the ductwork. By operating in this fashion, the probe (100) may be capable of indirectly detecting moisture ingress into the monitored sulfur trioxide gas stream. Specifically, the process gas dew point would increase when moisture is present in the sulfur trioxide gas stream. Thus, the probe (100) is typically operated above the dew point for pure sulfur trioxide gas but below the dew point of sulfur trioxide gas in the presence of moisture. Thus, a moisture leak condition may be detected even though the probe will not cause any condensation during normal operation because the presence of moisture would cause condensation resulting in electrical conductance of the glass sensor (115). Stated another way, under normal operating conditions, nothing should condense on the probe. However, when a gas leak allows additional moisture to enter the gas stream, sulfuric acid (moisture plus sulfur trioxide) will likely condense on the probe.

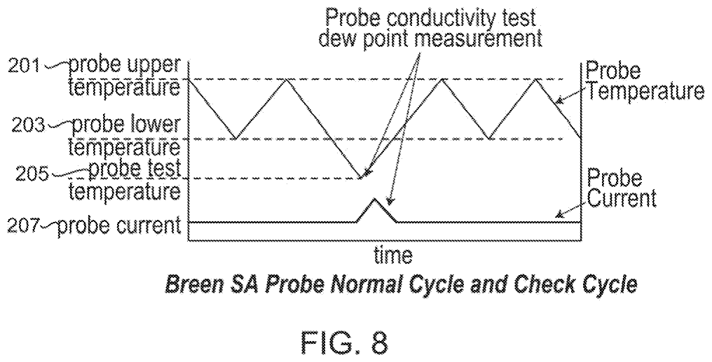

For example, the temperature of the glass sensor (115) may be cycled between an upper probe temperature (201) and a lower probe temperature (203), wherein both the upper probe temperature (201) and the lower probe temperature (203) are above the anticipated dew point of a sulfur trioxide gas stream being monitored. On the other hand, a probe test temperature (205) may be chosen that is below the dew point temperature of the sulfur trioxide gas stream. During normal cycling, the glass sensor (115) typically may be heated to the upper probe temperature (201) via the heat of the sulfur trioxide gas stream and lowered to the lower probe temperature (203) typically using cool air delivered to the glass sensor (115) via the cooling air inlet (111), as depicted in FIG. 8, in order to test the probe (100). At any time, the temperature of the glass sensor (115) may be brought down to the probe test temperature (205) in order to produce some formation of condensation on the glass sensor (115). Cooling the glass sensor (115) to such an extent may mimic the effects of moisture being introduced into the sulfur trioxide gas stream, and the glass sensor (115) may be able to detect the presence of condensate after the probe cools to the probe test temperature (205).

During normal cycling, there will be little to no current flowing between the first electrical contact (117) and the second electrical contact (119) on the outer surface of the glass sensor (115) because the outer surface of the glass sensor (115), where the first electrical contact (117) and the second electrical contact (119) are mounted, is nonconductive. This is because no condensate is able to form while the outer surface of the glass sensor (115) is kept above the dew point of the sulfur trioxide gas stream. However, as seen in FIG. 8, current may begin to flow as the temperature of the glass sensor (115) nears the probe test temperature (205) because conductive condensate may condense on the outer surface of the glass sensor (115) at this lower temperature. In particular, the formation of this conductive condensate may be seen as a spike in the probe current (207) shown in the center of the graph of current depicted in FIG. 8.

Such a spike in the probe current shows that the probe (100) is active and will respond to a condensation event. In particular, as the current increases from at or near zero current, it may be assumed that a conductive material has begun condensing on the outer surfaces of the glass sensor (115). As the current peaks, it may be assumed that the material condensing is at an equilibrium, wherein the rate of evaporation of the material and the rate of condensation of the material are the same. The temperature of the glass sensor (115) at this peak in current flow generally corresponds to the dew point temperature for the gas stream being tested. As the current decreases from the peak amount, it may be assumed that the material condensing on the glass sensor (115) is now evaporating more quickly than it is condensing. This decrease in current continues until all of the material, which material once condensed on the glass sensor (115), has now evaporated, leaving no further conductive material on the outer surface of the glass sensor (115).

In an embodiment, the stream of sulfur trioxide gas will have a process temperature of approximately 400 degrees Fahrenheit and will typically have a dew point of approximately 190 to 250 degrees Fahrenheit. Further, the upper probe temperature (201) may be approximately 350 degrees Fahrenheit and the lower probe temperature (203) may be approximately 285 degrees Fahrenheit. Further yet, the probe test temperature (205) may be approximately 240 degrees Fahrenheit. In other embodiments, the probe test temperature (205) may be approximately 230 degree Fahrenheit. In other embodiments, the upper probe temperature (201) and the lower probe temperature (203) may be any temperatures that are appropriate for operating outside of the dew point for the process gas being monitored, and the probe test temperature (205) may be any temperatures that is appropriate for operating under the dew point for the process gas being monitored.

A method (500) of operating the probe (100) is depicted in FIG. 11 and will now be described. First, the probe (100) may be activated or otherwise turned on so that the sensing and control equipment is operating (501). At this point in the process, the portions of the probe (100) that extend into the ductwork may be allowed to reach a temperature equilibrium with the gas stream being monitored. For the next step (503), the probe (100) may be operated by cooling the glass sensor (115) to the lower probe temperature (203) using the cooling air. In the following step (505), the gas sensor may be heated and cooled between the lower probe temperature (203) and the upper probe temperature (201). From the lower probe temperature (203), the glass sensor (115) may be heated using the heating air until the upper probe temperature (201) is reached. Then the glass sensor (115) may be cooled again using the cooling air until the lower probe temperature (203) is reached again. This process of heating and cooling (505) may be repeated indefinitely until a current is sensed by the glass sensor (115) in the next step (507). The sensing of an increased current may be used as an indication that moisture has been detected in the gas stream.

The gas sensor (115), in an embodiment of its typical usage to monitor a sulfur trioxide gas stream, may be operated when installed into ductwork carrying a sulfur trioxide gas stream between the upper probe temperature (201) and the lower probe temperature (203), each of which are above the dew point temperature for a pure sulfur trioxide gas stream. Without the presence of moisture, nothing should condense at any time on the outer surface of the glass sensor (115).

Accordingly, no current should flow between the first electrical contact (117) and the second electrical contact (119). However, when moisture is leaked or otherwise introduced into the sulfur trioxide gas stream being monitored, the overall dew point of the mixed gas stream may be considerably increased. This may cause an increase in the current flow between the electrical contacts. Thus, the gas sensor (115) will work to essentially continuously monitor the gas stream from the presence of moisture as moisture ingress should rapidly result in condensation on the glass sensor (115) which can be detected upon its occurrence.

Even the small amount of moisture introduced into a sulfur trioxide gas stream may increase the overall gas stream dew point temperature to a temperature that is above the lower probe temperature (203). Accordingly, in the presence of moisture within the sulfur trioxide gas stream, the probe's (100) normal operation above the dew point temperature of pure sulfur trioxide may cause condensation to form on the outer surface of the glass sensor (115). In turn, this condensation may cause current to flow between the first electrical contact (117) and the second electrical contact (119). Accordingly, this increase in current flow may be used as a proxy for the detection of moisture in a sulfur trioxide gas stream. Said another way, the probe (100) may be used as a detector for a change in the overall dew point of the process gas flowing with ductwork containing a sulfur trioxide gas stream being monitored by the probe (100). This change in dew point may be an indicator of the presence of moisture within the monitored sulfur trioxide gas stream.

In some embodiments, a sulfur dioxide or sulfur trioxide monitor may be placed downstream of the probe (100) within the cooling air stream, which cooling air stream may be used to operate the probe (100). In some situations wherein probe (100) is compromised due to breakage or otherwise, sulfur dioxide or sulfur trioxide from the gas stream being probed may enter into the cooling air stream. If sulfur dioxide or sulfur trioxide is introduced into the cooling gas stream being monitored, the monitor may detect the presence of sulfur dioxide or sulfur trioxide. In this case, the probe (100) or probe operator may take actions to prevent further spread of leaking gas from the gas stream being probed. For example, the cooling air inlet (111) and the cooling air outlet (113) may be closed by, for example, valves at each of the cooling air inlet (111) and the cooling air outlet (113).

In some embodiments, the heating air, or heat used to increase the temperature of the gas sensor (115) may be provided by the heat extant in the gas stream being probed. In such an embodiment, instead of supply heating air to the glass sensor (115) during thermal cycling, the cooling air will merely be removed, allowing the glass sensor (115) to heat up from the increased energy of the relevant gas stream. In such an embodiment, the gas stream being probed may be considered to be a heating portion of the probe (100).

As may be apparent from the above description, the probe (100) is capable of operating within a sulfur trioxide gas stream. In particular, the probe (100) may be operated without producing any substantial amount of corrosive condensate while operating in a gas stream that is effectively moisture-free, which is the desired operation. Further, in doing so, the probe (100) can still be able to quickly and accurately detect a change in the dew point of the gas stream being monitored, and, as a result, indirectly determine the presence of moisture within the monitored gas stream. By operating for majority of the time under conditions that do not produce corrosive condensate materials, the probe (100) may be maintained for a longer period of time, thus having a longer service life and less maintenance downtime.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “approximately,” and similar qualifiers as used in the present case, would be understood by one of ordinary skill in the art to accommodate recognizable attempts to conform a device to the qualified term, which may nevertheless fall short of doing so. This is because terms such as “cylindrical” and “rectangular prism” are purely geometric constructs and no real-world component is truly “cylindrical” or a true “rectangular prism” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “approximately” and relationships contemplated herein, regardless of the inclusion of such qualifiers to include a range of variations from the literal geometric meaning of the term in view of these and other considerations.

1. An industrial probe comprising:
a frame portion having an elongated shape;
a first sensor having an outer nonconductive surface supporting a plurality of electrical contacts;
a cooling portion having at least one conduit configured to cool said first sensor to a cooling temperature;
a heating portion having at least one conduit configured to heat said first sensor to a heating temperature;
wherein said first sensor is located proximate to a first terminal end of said frame portion;
wherein said heating temperature is greater than said cooling temperature; and
wherein said first sensor is repeatedly cycled between said cooling temperature and said heating temperature.

2. The industrial probe of claim 1, wherein said heating temperature is approximately 350 degrees Fahrenheit or higher and said cooling temperature is within a range between approximately 250 degrees Fahrenheit and approximately 285 degrees Fahrenheit.

3. The industrial probe of claim 2, wherein said first sensor is further configured to be cooled to a test temperature, said test temperature being approximately 240 degrees Fahrenheit.

4. The industrial probe of claim 1, wherein said cooling portion further comprises an inlet and an outlet, each being located proximate to a second terminal end of said frame portion and each having a ball valve configured to be normally closed.

5. The industrial probe of claim 4, further comprising a source of cooling air and a source of heating air, wherein said source of cooling air and said source of heating air are each located remotely from said frame portion.

6. The industrial probe of claim 1, further comprising a mechanical deflector that is configured to protect said first sensor from impacts.

7. The industrial probe of claim 6, wherein said mechanical deflector includes a plurality of open sections that are each configured to allow said first sensor to come into contact with a gas in an environment proximate to said first sensor.

8. The industrial probe of claim 1, further comprising a second sensor, said second sensor being located downstream of said outlet and being capable of detecting the presence of sulfur trioxide within said cooling air.

9. The industrial probe of claim 1, wherein said frame portion is substantially cylindrical in form.

10. The industrial probe of claim 9, wherein said frame portion is generally smooth on its exterior.

11. The industrial probe of claim 1, further comprising wiring connected to each electrical contact of said plurality of electrical contacts, and wherein said wiring is positioned to extend through a gland that is located proximate to said second terminal end of said frame portion.

12. The industrial probe of claim 1, wherein said industrial probe is configured to prevent the transmission of an unwanted gas through said industrial probe in the event that said unwanted gas enters said industrial probe at said first terminal end of said frame portion.

13. The industrial probe of claim 1, wherein said heating temperature is below a process temperature of a sulfur trioxide stream monitored by said probe and said cooling temperature is above the dew point of sulfur trioxide in said sulfur trioxide stream.

14. The industrial probe of claim 13, wherein said first sensor is further configured to be cooled to a test temperature, said test temperature being cooler than said dew point of said sulfur trioxide in said sulfur trioxide stream.

15. The industrial probe of claim 1, wherein said first sensor is further configured to be cooled to a test temperature, said test temperature being cooler than said cooling temperature.

16. The industrial probe of claim 1, wherein said heating portion is a sulfur trioxide stream monitored by said probe.

17. A method for detecting moisture ingress into a sulfur trioxide stream, the method comprising:
providing an industrial probe, said industrial probe comprising:
a first sensor having an outer nonconductive surface supporting a plurality of electrical contacts;
a cooling portion having at least one conduit configured to cool said first sensor to a cooling temperature; and
a heating portion having at least one conduit configured to heat said first sensor to a heating temperature;
cooling said first sensor to a cooling temperature;
heating said first sensor to a heating temperature, said heating temperature being greater than said cooling temperature;
monitoring a current flow between said plurality of electrical contacts; and
indicating moisture ingress if said current is greater at said cooling temperature than at said heating temperature.

18. The method of claim 17, wherein said heating temperature is below a process temperature of said sulfur trioxide stream and said cooling temperature is above the dew point of sulfur trioxide in said sulfur trioxide stream.

19. The method of claim 18, further comprising a step of cooling said first sensor to a test temperature, said test temperature being cooler than said dew point of said sulfur trioxide in said sulfur trioxide stream.

20. The method of claim 17, wherein said heating temperature is approximately 350 degrees Fahrenheit or higher and said cooling temperature is within a range between approximately 250 degrees Fahrenheit and approximately 285 degrees Fahrenheit.
